(19) United States
(12) Patent Application Publication
(10) Pub. No.: US 2014/0165946 A1
(43) Pub. Date: Jun. 19, 2014

(54) POWER TOOL

(71) Applicant: MAKITA CORPORATION, Aichi (JP)

(72) Inventors: Kenya YANAGIHARA, Anjo-shi (JP); Hideo KAWASHIMA, Anjo-shi (JP); Yoshitaka ICHIKAWA, Anjo-shi (JP); Shinji HIRABAYASHI, Anjo-shi (JP)

(73) Assignee: MAKITA CORPORATION, Aichi (JP)

(21) Appl. No.: 14/097,366

(22) Filed: Dec. 5, 2013

(30) Foreign Application Priority Data
Dec. 14, 2012 (JP) 2012-272978

(51) Int. Cl. F02B 63/02

(52) U.S. Cl. CPC F02B 63/02
USPC 123/179.1

(57) ABSTRACT

To attain further rationalization in a power tool in which a tool bit is driven by an engine. During driving of the saw chain, when the user returns a throttle lever to its initial position by releasing only the throttle lever while keeping pressing a throttle lock lever, or when the user returns the throttle lever to the initial position by releasing the throttle lever and releases the throttle lock lever, driving of an engine is stopped. Thus, further rationalization can be attained in the power tool.

### BACKGROUND OF THE INVENTION

1. Field of the Invention

The invention relates to a power tool in which a tool bit is driven by an engine and performs a predetermined operation on a workpiece.

Cross reference is made to the Japanese patent application JP2012-272978 filed on Dec. 14, 2012, the entire contents of which are herein incorporated by reference.

2. Description of the Related Art

Japanese laid-open Patent Publication No. 2011-244724 discloses a bush cutter in which a tool bit is driven using an engine as a driving source.

According to the known bush cutter, engine driving output is used both for cutting operation and for charging a battery when being idled.

### SUMMARY OF THE INVENTION

On the other hand, efficient engine driving control is desired in terms of energy saving operation.

Accordingly, it is an object of the invention to attain further rationalization in a power tool in which a tool bit is driven by an engine.

Above described object is achieved by the claimed invention. According to a preferred aspect of the invention, a representative power tool is provided which includes an engine for driving a tool bit, a starting member that is operated to start the engine, an operating member that is operated to adjust an output of the engine, and a controller that stops driving of the engine for an idling stop according to the operation of the operating member. The “power tool” in the invention typically and suitably includes a chain saw, a hedge trimmer, a power cutter or other similar handheld power tools. The “starting member” in the invention typically represents a start switch, but, if it is required to stop the engine, it may represent a start-stop switch which also serves as a stop switch. The manner of “adjusting an output of the engine” in the invention typically and suitably includes a manner of adjusting the magnitude of the output torque to be outputted to the output shaft of the engine, and a manner of adjusting the rotating speed of the output shaft of the engine. The “operating member” in the invention typically represents a throttle lever and an accelerator lever.

According to the invention, driving of the engine is stopped according to the operation of the operating member which is operated to adjust the output of the engine. With this construction, further rationalization can be attained in the power tool.

According to a further aspect of the invention, the operating member can be placed into an initial position in which the operating member is not operated yet and an operated position in which the operating member has been operated. Further, the controller stops driving of the engine when the operating member is returned from the operated position to the initial position.

According to this aspect, driving of the engine is stopped when the operating member is returned from the operated position to the initial position. In other words, driving of the engine is stopped when the output of the engine is not required. With this construction, further rationalization can be attained in the power tool, and unnecessary fuel consumption and emission can be reduced.

According to a further aspect of the invention, the controller stops driving of the engine after a lapse of a first predetermined time since the operating member has been returned from the operated position to the initial position.

According to this aspect, driving of the engine is stopped after a lapse of the first predetermined time since the operating member has been returned from the operated position to the initial position. In other words, driving of the engine is not stopped until the first predetermined time elapses. With this construction, further rationalization can be attained in the power tool.

According to a further aspect of the invention, the controller restarts the engine without operating the starting member when the operating member is placed into the operated position again.

According to this aspect, when the operating member is placed into the operated position again after driving of the engine is stopped, the engine is restarted without operating the starting member. With this construction, the operation can be promptly restarted, so that the work efficiency can be improved.

According to a further aspect of the invention, the power tool further includes a switching member which is selectively placed in either one of an operation enabled position in which operation of the operating member from the initial position to the operated position is enabled and an operation disabled position in which operation of the operating member from the initial position to the operated position is disabled. Further, when the operating member is returned from the operated position to the initial position and the switching member is returned from the operation enabled position to the operation disabled position, the controller restarts the engine only by operation of the starting member.

According to this aspect, when the operating member is returned from the operated position to the initial position and the switching member is returned from the operation enabled position to the operation disabled position, the engine is not restarted, or the power tool itself is stopped, unless the starting member is operated. With this construction, further rationalization can be attained in the power tool. Further, the operating member cannot be switched from the initial position to the operated position, or the tool bit cannot be driven, until the switching member is switched from the operation disabled position to the operation enabled position. With this construction, the tool bit can be prevented from being driven by user's unintentional operation of the operating member.

According to a further aspect of the invention, only when the operating member is placed into the operated position again within a second predetermined time with the switching member kept in the operation enabled position, the controller restarts the engine without operating the starting member.

According to this aspect, if the operating member is returned to the initial position with the switching member kept in the operation enabled position and thus driving of the engine is stopped, the engine is restarted without operating the starting member only when the operating member is placed into the operated position again within the second predetermined time after the return of the operating member to the initial position. In other words, when the operating member is not placed into the operated position again even after the lapse of the second predetermined time since driving of the engine is stopped by returning the operating member to the initial position with the switching member kept in the operation enabled position, the engine is not restarted unless the starting member is operated. With this construction, further rationalization can be attained in the power tool.

According to a further aspect of the invention, the power tool further includes a housing that houses the engine, and a first handle to be held by a user. Further, the first handle protrudes from the housing, and the operating member and the switching member are provided on the first handle.

According to this aspect, both the operating member and the switching member are provided on the first handle. With this construction, the user can operate both of the members with the hand holding the first handle.

According to a further aspect of the invention, the operating member is provided in a region of the first handle which comes in contact with user's fingers, and the switching member is provided in a region of the first handle which comes in contact with user's palm.

According to this aspect, when the user holds the first handle, the user can operate the operating member with the palm of the hand holding the first handle, and at the same time, the user can also operate the switching member with the fingers of the same hand. Therefore, the operating member and the switching member are improved in operability.

According to a further aspect of the invention, the power tool further includes a housing that houses the engine, and a first handle and a second handle to be held by a user. Further, the first and second handles protrude from the housing, and the operating member is provided on the first handle and the switching member is provided on the second handle.

According to this aspect, the operating member is provided on the first handle and the switching member is provided on the second handle. Thus, the user can operate the operating member with the hand holding the first handle and can operate the switching member with the other hand holding the second handle.

According to a further aspect of the invention, the power tool further includes an informing member for informing the user that the power tool is ready to restart the engine by user's operation of the operating member from the initial position to the operated position.

According to this aspect, it is informed that the power tool is ready to automatically restart the engine by user's operation of switching the operating member from the initial position to the operated position. Thus, the user can recognize this status of the engine.

### Effect of the Invention

According to the invention, further rationalization can be attained in a power tool in which a tool bit is driven by an engine. Other objects, features and advantages of the present invention will be readily understood after reading the following detailed description together with the accompanying drawings and the claims.

### BRIEF DESCRIPTION OF THE DRAWINGS

FIG. 1 is a configuration diagram schematically showing the configuration of a chain saw 100.

FIG. 2 is a sectional view taken along line II-II of FIG. 1.

FIG. 3 is a configuration diagram schematically showing the configuration of a modified chain saw 100A.

### DETAILED DESCRIPTION OF THE INVENTION

Each of the additional features and method steps disclosed above and below may be utilized separately or in conjunction with other features and method steps to provide and manufacture improved power tools and method for using such power tools and devices utilized therein. Representative examples of the present invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention, which detailed description will now be given with reference to the accompanying drawings.

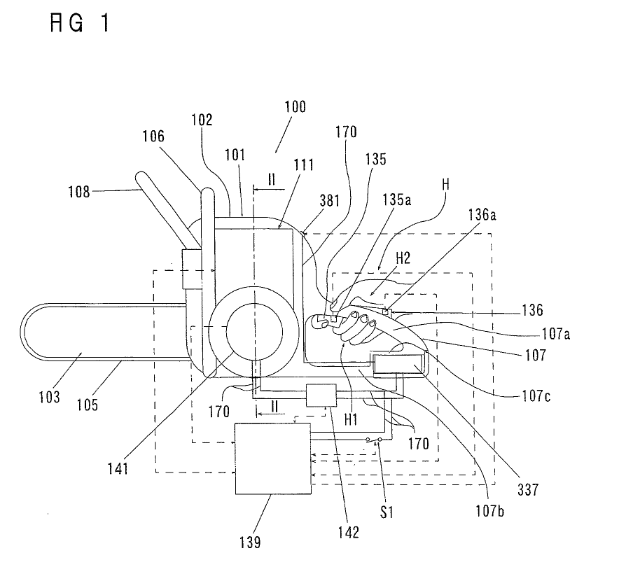

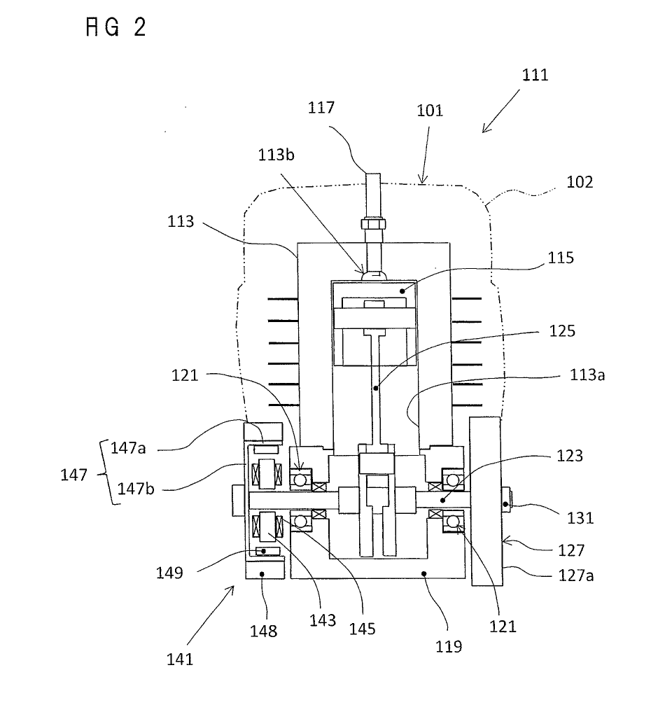

A representative embodiment of the invention is now described with reference to FIGS. 1 and 2. In this embodiment, a chain saw is described as a representative embodiment of a power tool according to the invention. FIG. 1 is a configuration diagram schematically showing the configuration of a chain saw 100. As shown in FIG. 1, the chain saw 100 mainly includes a body 101 which forms an outer shell of the chain saw 100, a guide bar 103 which protrudes horizontally from one side of the body 101, a front handle 106, a rear handle 107 and a hand guard 108 which are connected to the body 101, and a controller 139 which controls the entire chain saw 100. The chain saw 100 is designed as a cutting tool that performs a cutting operation on a workpiece by rotating a saw chain 105 mounted on a guide bar 103. The chain saw 100, the saw chain 105, the rear handle 107 and the controller 139 are features that correspond to the “power tool”, the “tool bit”, the “first handle” and the “controller”, respectively, according to the invention. In this embodiment, for the sake of convenience of explanation, the side of the protruding guide bar 103 (the left side as viewed in FIG. 1) is taken as the “front” or “front region” and its opposite side (the rear handle 107 side, the right side as viewed in FIG. 1) as the “rear” or “rear region”.

FIG. 2 is a sectional view taken along line II-II of FIG. 1. As shown in FIG. 2, the body 101 mainly includes an engine 111 and an electric motor 141 which both serve to drive the saw chain 105, and a body housing 102 which houses the engine 111 and the electric motor 141. Therefore, the chain saw 100 according to this embodiment is configured as a hybrid power tool that is driven by both the engine 111 and the electric motor 141. The engine 111 and the body housing 102 are features that correspond to the “engine” and the “housing”, respectively, according to the invention.

As shown in FIG. 2, the engine 111 is configured as a reciprocating engine which mainly includes a cylinder block 113, a piston 115, a spark plug 117, a crank case 119, a crank shaft 123 and a connecting rod 125. In this embodiment, a single-cylinder, two-stroke small engine is used as the engine 111.

As shown in FIG. 2, the cylinder block 113 has a cylinder bore 113a in which the piston 115 can slide, and a combustion chamber 113b which is formed in a recessed shape at the upper end of the cylinder bore 113a. An internal-combustion chamber is defined by a region surrounded by the cylinder bore 113a, the combustion chamber 113b and the piston 115. The volume of the internal-combustion chamber is compressed and expanded by sliding of the piston 115 within the cylinder bore 113a. The spark plug 117 is provided on the combustion chamber 113b. The crank case 119 is provided below the cylinder block 113 and connected to the cylinder block 113.

As shown in FIG. 2, the crank shaft 123 is rotatably supported by the crank case 119 via a plurality of bearings 121. The crank shaft 123 is arranged such that its axis extends perpendicularly to the axial direction of the cylinder bore 113a (the vertical direction as viewed in FIG. 2) and to the extending direction of the guide bar 103 (the horizontal direction as viewed in FIG. 1, a direction perpendicular to the plane of FIG. 2). The crank shaft 123 is connected to the piston 115 via the connecting rod 125. Thus, linear motion of the piston 115 is converted into rotation of the crank shaft 123.

As shown in FIG. 2, one end (left end as viewed in FIG. 2) of the crank shaft 123 protrudes through one side of the crank case 119, and the electric motor 141 which is described below is mounted on this end. The other end (right end as viewed in FIG. 2) of the crank shaft 123 protrudes through the other side of the crank case 119, and a centrifugal clutch 127 is mounted on this end.

The centrifugal clutch 127 is configured to cause a clutch shoe (not shown) to expand radially outward and get in contact with an inner circumferential surface of a clutch outer 127a by using centrifugal force which is developed by rotation of the crank shaft 123. With this construction, rotation of the clutch shaft 123 can be transmitted to the clutch outer 127a. A final output shaft 131 is fixedly mounted coaxially with the crank shaft 123 on the outer surface (on the right side as viewed in FIG. 2, facing away from the crank case 119) of the clutch outer 127a and connected to the saw chain 105.

As shown in FIG. 2, the electric motor 141 is configured as an outer rotor motor having a stator core 143, a stator coil 145, an outer rotor 147 and a magnet 149. The electric motor 141 is capable of rotating in both forward and reverse directions and serves not only as a motor for assisting drive of the engine 111, but as a generator and a cell motor for starting the engine 111.

The stator core 143 is a disc-like member formed of magnetic material and fixedly mounted to the outer surface of the crank case 119. As shown in FIG. 2, the stator core 143 has a center hole in its center, and the crank shaft 123 is loosely fitted through the center hole. The stator coil 145 is wound on the stator core 143 and excites the stator core 143 when energized.

As shown in FIG. 2, the outer rotor 147 is a cup-like member having a cylindrical peripheral wall 147a and a bottom wall 147b, and the peripheral wall 147a surrounds the outer circumferential surface of the stator core 143. The magnet 149 is arranged on the inner circumferential surface of the peripheral wall 147a such that it faces the outer circumferential surface of the stator core 143. Further, a cooling fan 148 is provided on the outer circumferential surface of the peripheral wall 147a. The crank shaft 123 is coaxially connected to the center of the bottom wall 147b, so that the crank shaft 123 also serves as a rotation axis of the electric motor 141. Thus, rotation of the crank shaft 123 and the rotation axis of the electric motor 141 is transmitted to the final output shaft 131. Here, however, by means of the centrifugal clutch 127, rotation of the crank shaft 123 or the rotation axis of the electric motor 141 is not transmitted to the final output shaft 131 in a region in which rotation speed of the crank shaft 123 and the rotation axis of the electric motor 141 is lower than a predetermined speed, while it is transmitted to the final output shaft 131 in a region in which rotation speed of the crank shaft 123 and the rotation axis of the electric motor 141 is higher than the predetermined speed.

A motor control circuit 142 includes a plurality of switching elements (not shown). The controller 139 controls switching of the switching elements to start and stop supply of electric current to the electric motor 141. Thus, driving of the electric motor 141 is controlled.

As shown in FIG. 1, an LED 381 is provided on the body housing 102 at a position which can be visually recognized by the user during cutting operation on a workpiece. The LED 381 is a light-emitting diode which emits light by electric current supplied from a battery pack 337 which is described below. The LED 381 is a feature that corresponds to the “informing member” according to the invention.

As shown in FIG. 1, the rear handle 107 is connected to a lower region of a rear end of the body housing 102 and extends rearward, and has a shape of a generally triangular loop having an opening at the center in side view. Specifically, the rear handle 107 has an upper part 107a and a lower part 107b, and the upper part 107a and the lower part 107b are connected to each other at their rear ends.

The upper part 107a of the rear handle 107 is connected to a central part of the rear end of the body housing 102 and extends rearward and obliquely downward in a curved shape. The upper part 107a forms a grip to be held by a user. In a region of the upper part 107a facing the central opening (on the lower side as viewed in FIG. 1) which comes in contact with user's fingers, as shown in FIG. 1, a throttle lever 135 is provided and configured to be depressed with a user's finger. The amount of inflow of air-fuel mixture to be supplied to the engine 111 can be controlled by adjusting the depressing amount of the throttle lever 135. Thus, the throttle lever 135 is configured as an operating member for adjusting the magnitude of the output torque to be outputted to the crank shaft 123. Further, the throttle lever 135 also serves as an operating member for adjusting the magnitude of the output torque to be outputted from the electric motor 141 to the crank shaft 123. The throttle lever 135 is a feature that corresponds to the “operating member” according to the invention.

Further, as shown in FIG. 1, a throttle lock lever 136 is provided in a region of the upper part 107a on the opposite side from the throttle lever 135 (on the side facing away from the central opening, on the upper side as viewed in FIG. 1) or a region of the upper part 107a which comes in contact with user's palm. The throttle lock lever 136 is an operating member for locking the throttle lever 135 (disabling depressing operation) in its initial position in which the throttle lever 135 is not depressed yet. When the user presses the throttle lock lever 136 with the palm, the throttle lever 135 is enabled to be depressed. Specifically, the throttle lock lever 136 can be switched between an operation enabled position to enable the throttle lever 135 to be depressed and an operation disabled position to disable the throttle lever 135 to be depressed. The initial position in which the throttle lever 135 is not depressed yet and the position in which the throttle lever 135 has been depressed are features that correspond to the “initial position” and the “operated position”, respectively, according to the invention. Further, the throttle lock lever 136, the position in which the throttle lock lever 136 is in the operation enabled position, and the position in which the throttle lock lever 136 is in the operation disabled position are features that correspond to the “switching member”, the “operation enabled position” and the “operation disabled position”, respectively, according to the invention.

With the above-described construction, the user cannot operate the throttle lever 135 until the user switches the throttle lock lever 136 from the operation disabled position to the operation enabled position. Thus, the saw chain 105 can be prevented from being driven by user's unintentional operation of the throttle lever 135. Therefore, safety of the chain saw 100 can be enhanced. Further, with the construction in which the throttle lever 135 is provided in a region of the upper part 107a of the rear handle 107 (facing the central opening, on the lower side as viewed in FIG. 1) which comes in contact with user's fingers, while the throttle lock lever 136 is provided in a region of the upper part 107a of the rear handle 107 (facing away from the central opening, on the upper side as viewed in FIG. 1) which comes in contact with user's palm, the user can easily operate both the throttle lever 135 and the throttle lock lever 136 with the hand holding the grip of the rear handle 107. Thus, the chain saw 100 can be rationally operated. Here, the construction of the throttle lock lever 136 is not described in detail.

In addition to the throttle lever 135 and the throttle lock lever 136, a button (not shown) is provided on the upper part 107a of the rear handle 107 and pushed by the user in order to start and stop the chain saw 100. In this embodiment, every time the user pushes the button, a power switch S1 is turned on and off. The power switch S1 is not only turned on and off by user's push of the button, but turned off by a switching control signal from the controller 139 which is described below. It may be constructed such that the power switch S1 is turned off only by a switching control signal from the controller 139. The power switch S1 is a feature that corresponds to the “starting member” according to the invention.

The lower part 107b of the rear handle 107 is connected to a rear lower end of the body housing 102 and extends horizontally rearward. As shown in FIG. 1, a battery mounting part 107c is provided in the connecting region between the upper part 107a and the lower part 107b of the rear handle 107. The battery pack 337 is mounted in the battery mounting part 107c. The battery pack 337 is electrically connected to the controller 139, the electric motor 141 and the LED 381 via power lines 170 and can supply electric current to the controller 139, the electric motor 141 and the LED 381. Further, when the electric motor 141 serves as a generator, generated current is supplied to the battery pack 337 via the power line 170 so that the battery pack 337 can be recharged. The battery pack 337 is a battery case containing a plurality of battery cells.

The controller 139 is configured as a microprocessor including a CPU. As shown in FIG. 1, the controller 139 receives, via an input port, chain-saw start and stop signals, throttle lever position signals from a throttle lever position sensor 135a, throttle lock lever position signals from a throttle lock lever position sensor 136a, and other various signals relating to the operating status of the engine 111, the operating status of the electric motor 141 and the switching status of the motor control circuit 142. The throttle lever position sensor 135a detects whether the throttle lever 135 is in the initial position or in the depressed position, and the throttle lock lever position sensor 136a detects whether the throttle lock lever 136 is in the operation enabled position or in the operation disabled position. The throttle lever position sensor 135a and the throttle lock lever position sensor 136a are activated by electric current supplied from the battery pack 337.

Further, the controller 139 outputs, via an output port, various drive control signals for driving the engine 111, a switching control signal to the motor control circuit 142, a switching control signal to the power switch S1, and a lighting signal to the LED 381. In FIG. 1, for the convenience of explanation, the motor control circuit 142, the power lines 170, the power switch S1 and the controller 139 are shown outside the chain saw 100.

Operation of the chain saw 100 having the above-described construction according to this embodiment, particularly its operation at the time of start and stop of the engine 111 by user's operation of the throttle lever 135 and the throttle lock lever 136, is now described.

When the user pushes the button to start the chain saw 100, the power switch S1 is turned on, and electric current is supplied from the battery pack 337 to the controller 139 and activates the controller 139. At the same time, a chain-saw start signal is inputted to the controller 139. Then, the controller 139 controls the electric motor 141 to crank the engine 111 and also controls the engine 111 to supply air-fuel mixture to the combustion chamber 113b of the cranked engine 111 and ignite the supplied mixture. Thus, the engine 111 starts and runs at idle.

After start of the engine 111, when the user switches the throttle lock lever 136 to the operation enabled position and depresses the throttle lever 135, the throttle lever position sensor 135a detects that the throttle lever 135 is depressed and the throttle lock lever position sensor 136a detects that the throttle lock lever 136 is in the operation enabled position. Then, the throttle lever position signal and the throttle lock lever position signal are inputted to the controller 139. Thus, the controller 139 controls the engine 111 to drive the saw chain 105. At this time, when the output torque of the engine 111 alone is not enough, the controller 139 controls the electric motor 141 to compensate for the shortfall in output torque with the output torque of the electric motor 141. On the other hand, when the output torque of the engine 111 is enough, the controller 139 controls the electric motor 141 to serve as a generator.

During driving of the saw chain 105, when the user releases only the throttle lever 135 while keeping pressing the throttle lock lever 136 (in the operation enabled position), the throttle lever 135 is returned to the initial position. At this time, the throttle lever position sensor 135a detects that the throttle lever 135 is in the initial position and the throttle lock lever position sensor 136a detects that the throttle lock lever 136 is in the operation enabled position. Then, the throttle lever position signal and the throttle lock lever position signal are inputted to the controller 139. Thus, the controller 139 controls the engine 111 to stop driving of the engine 111 and lights up the LED 381. When not only the engine 111 but the electric motor 141 is being driven, driving of the electric motor 141 is also stopped.

Here, driving of the engine 111 is stopped after a lapse of a first predetermined time since the throttle lever 135 has been returned to the initial position (since the throttle lever position sensor 135a has detected that the throttle lever 135 is in the initial position). In other words, driving of the engine 111 is stopped only after the lapse of the first predetermined time. This construction is provided in order to prevent the engine 111 from being stopped, for example, when the user unintentionally returns the operating member from the operated position to the initial position, or even when the user idles the engine for the purpose of improving startability of the engine 111 by returning the operating member from the operated position to the initial position. With this construction, further rationalization can be attained in the power tool. The first predetermined time here can be arbitrarily set to a reasonable period of time (for example, one to two seconds) to determine that the user has an intention to temporarily suspend the cutting operation.

When the user depresses the throttle lever 135 again while keeping pressing the throttle lock lever 136 (in the operation enabled position) within a second predetermined time after stop of driving of the engine 111, the throttle lever position sensor 135a detects that the throttle lever 135 is depressed and the throttle lock lever position sensor 136a detects that the throttle lock lever 136 is in the operation enabled position. Then, the throttle lever position signal and the throttle lock lever position signal are inputted to the controller 139. Thus, the controller 139 controls the engine 111 and the electric motor 141 to restart the engine 111. The second predetermined time here can be arbitrarily set to a reasonable period of time to determine that the cutting operation has been temporarily suspended.

As described above, when the throttle lever 135 is returned to the initial position with the throttle lock lever 136 kept pressed (in the operation enabled position) after start of cutting operation, driving of the engine 111 is stopped and the LED 381 is lit. Further, when the throttle lever 135 is depressed again within the second predetermined time after stop of driving of the engine 111 with the throttle lock lever 136 kept pressed (in the operation enabled position), the engine 111 is restarted without user's push of the button. With this construction, further rationalization can be attained in the power tool. Moreover, such construction can reduce unnecessary fuel consumption and emission, so that it can contribute to environmental protection. In addition, the cutting operation can be promptly restarted, so that the work efficiency can be improved. Further, the LED 381 can inform the use by lighting that the chain saw 100 is ready to restart the engine 111 by user's operation of depressing the throttle lever 135, so that the user can recognize this status of the engine 111.

When the throttle lever 135 is returned to the initial position with the throttle lock lever 136 kept pressed (in the operation enabled position), driving of the engine 111 is stopped, but supply of electric current from the battery pack 337 to the controller 139, the electric motor 141, the sensors (the throttle lever position sensor 135a, the throttle lock lever position sensor 136a) and the LED 381 is continued. In other words, so-called idling stop (no idling or idle reduction) is realized where only driving of the engine 111 is stopped while the chain saw 100 itself is kept in its startup state. With this construction, the engine 11 can be restarted without user's push of the button.

Further, when the second predetermined time elapses since stop of driving of the engine 111, the controller 139 controls the power switch S1 and the motor control circuit 142 to shut off the supply of electric current from the battery pack 337 to the controller 139, the electric motor 141, the sensors (the throttle lever position sensor 135a, the throttle lock lever position sensor 136a) and the LED 381. In other words, the chain saw 100 itself is stopped. With this construction, even if the user depresses the throttle lever 135 again while keeping pressing the throttle lock lever 136 (in the operation enabled position), the engine 111 is not restarted. Unless the user pushes the button, the engine 111 cannot be restarted.

During driving of the saw chain 105, when the user releases the throttle lever 135 to return it to the initial position and switches the throttle lock lever 136 from the operation enabled position to the operation disabled position, the throttle lever position sensor 135a detects that the throttle lever 135 is in the initial position and the throttle lock lever position sensor 136a detects that the throttle lock lever 136 is in the operation disabled position. Then, the throttle lever position signal and the throttle lock lever position signal are inputted to the controller 139. Thus, the controller 139 stops the chain saw 100 itself.

When the user returns the throttle lever 135 to the initial position by releasing only the throttle lever 135 while keeping pressing the throttle lock lever 136 (in the operation enabled position), the engine 111 is stopped, and further, in this state, when the user releases the throttle lock lever 136 or switches it from the operation enabled position to the operation disabled position, the controller 139 also stops the chain saw 100 itself.

By provision of such construction in which the chain saw 100 itself is stopped when the throttle lever 135 is returned to the initial position and the throttle lock lever 136 is switched to the operation disabled position, further rationalization can be attained in the power tool. Further, such construction can reduce not only unnecessary fuel consumption and emission, but unnecessary power consumption, so that it can further contribute to environmental protection. Here, the chain saw 100 can also be stopped by user's push of the button.

When stopping driving of the engine 111, the controller 139 controls the engine 111 to stop supplying air-fuel mixture to the combustion chamber 113b of the engine 111 and to stop igniting the mixture, and thereafter, the controller 139 controls the electric motor 141 to rotate the crank shaft 123 so as to stop the piston 115 substantially at a bottom dead point. With this construction, compared with a construction in which the piston 115 is stopped at a position other than the vicinity of the bottom dead point, load which is applied to the electric motor 141 upon restart of the engine 111 can be reduced. In a multicylinder engine having a plurality of pistons, it is impossible to stop all of the pistons at the vicinity of the bottom dead point, so that a limit exists for reducing load which is applied to the electric motor 141 upon restart of the engine 111. In this embodiment, however, a single-cylinder engine is used as the engine 111, so that load which is applied to the electric motor 141 upon restart of the engine 111 can be effectively reduced by controlling only the piston 115 to stop at the vicinity of the bottom dead point. Thus, the engine can be restarted smoothly, and unnecessary fuel consumption can be further reduced.

According to the above-described embodiment of the invention, during driving of the saw chain 105, when the user returns the throttle lever 135 to the initial position by releasing only the throttle lever 135 while keeping pressing the throttle lock lever 136 (in the operation enabled position), the engine 111 is stopped. Therefore, further rationalization can be attained in the power tool. Further, unnecessary fuel consumption and emission by the engine 111 can be reduced.

Further, according to this embodiment, the engine 111 is stopped after a lapse of the first predetermined time since the throttle lever 135 has been returned to the initial position. In other words, even if the throttle lever 135 is returned to the initial position, the engine 111 is not stopped until the first predetermined time elapses. With this construction, further rationalization can be attained in the power tool.

Further, according to this embodiment, when the user depresses the throttle lever 135 from the initial position within the second predetermined time after stopping the engine 111 by releasing only the throttle lever 135 while keeping pressing the throttle lock lever 136 (in the operation enabled position), the engine 111 is restarted without user's push of the button. With this construction, the cutting operation can be promptly restarted, so that the work efficiency can be improved.

Further, according to this embodiment, when the user releases the throttle lever 135 to return it to the initial position and switches the throttle lock lever 136 from the operation enabled position to the operation disabled position, or when the user does not depress the throttle lever 135 again within the second predetermined time after stopping the engine 111 by releasing only the throttle lever 135 while keeping pressing the throttle lock lever 136 (in the operation enabled position), the chain saw 100 itself is stopped. With this construction, further rationalization can be attained in the power tool.

Further, according to this embodiment, the throttle lever 135 is provided in a region of the upper part 107a of the rear handle 107 which comes in contact with user's fingers, while the throttle lock lever 136 is provided in a region of the upper part 107a of the rear handle 107 which comes in contact with user's palm. With this construction, the user can easily operate both the throttle lever 135 and the throttle lock lever 136 with the hand holding the grip of the rear handle 107.

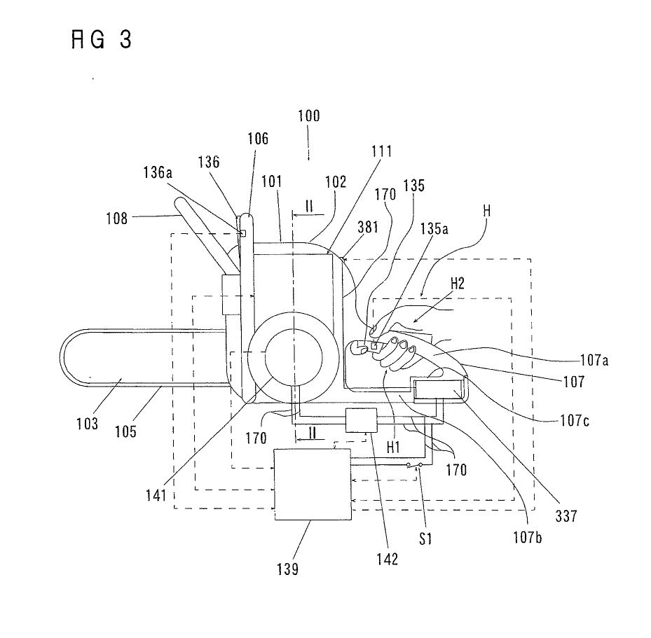

In this embodiment, both the throttle lever 135 and the throttle lock lever 136 are provided on the rear handle 107, but the arrangement is not limited to this. For example, like a modified chainsaw 100A shown in FIG. 3, the throttle lever 135 may be provided on the rear handle 107, and the throttle lock lever 136 may be provided on the front handle 106. In this case, the throttle lever 135 can be operated with one hand holding the rear handle 107, and the throttle lock lever 136 can be operated with the other hand holding the front handle 106. Thus, the user can operate the throttle lever 135 and the throttle lock lever 136 with the separate hands. The front handle 106 is a feature that corresponds to the “second handle” according to the invention.

Further, in this embodiment, the LED 381 is provided on the chain saw 100 in order to inform the user that the chain saw 100 is ready to restart the engine 111 by user's operation of depressing the throttle lever 135, but such informing means is not limited to this. For example, a speaker which generates sound or an actuator which generates vibration may be provided on the chain saw 100.

Further, in this embodiment, the chain saw 100 is described as a hybrid power tool that is driven by both the engine 111 and the electric motor 141, but it is not necessary to be a hybrid power tool only if it has an engine as a prime mover and a motor that can start the engine.

Further, in this embodiment, the throttle lock lever 136 is provided, but it may not necessarily be provided.

Further, in this embodiment, the chain saw 100 is described as a representative example of the power tool according to the invention. However, the invention can also be applied to other power tools, such as a bush cutter, a hammer drill and a circular saw, having an engine and a motor.

### Correspondences Between the Features of the Embodiment and the Features of the Invention

This embodiment is a representative example for embodying the invention, and the invention is not limited to the constructions that have been described as the representative embodiment. Correspondences between the features of the embodiment and the features of the invention are as follow:

The chain saw 100, 100A corresponds to the “power tool” according to the invention.

The saw chain 105 corresponds to the “tool bit”.

The rear handle 107 corresponds to the “first handle”.

The front handle 106 corresponds to the “second handle”.

The controller 139 corresponds to the “controller”.

The engine 111 corresponds to the “engine”.

The body housing 102 corresponds to the “housing”.

The LED 381 corresponds to the “informing member”.

The throttle lever 135 corresponds to the “operating member”.

The throttle lock lever 136 corresponds to the “switching member”.

The position in which the throttle lever 135 has been depressed corresponds to the “operated position”.

The initial position in which the throttle lever 135 is not depressed yet corresponds to the “initial position”.

The position in which the throttle lock lever 136 is in the operation enabled position corresponds to the “operation enabled position”.

The position in which the throttle lock lever 136 is in the operation disabled position corresponds to the “operation disabled position”.

The power switch S1 corresponds to the “starting member”.

### DESCRIPTION OF NUMERALS

100, 100A chain saw (power tool)
101 body
102 body housing (housing)
105 saw chain (tool bit)
106 front handle (second handle)
107 rear handle (first handle)
107a upper part
107b lower part
107c battery mounting part
108 hand guard
111 engine (engine)
113 cylinder block
113a cylinder bore
113b combustion chamber
115 piston
117 spark plug
119 crank case
123 crank shaft
125 connecting rod
127 centrifugal clutch
127a clutch outer
131 final output shaft
135 throttle lever (operating member)
135a throttle lever position sensor
136 throttle lock lever (switching member)
136a throttle lock lever position sensor
139 controller (controller)
141 electric motor (motor)
142 motor control circuit
143 stator core
145 stator coil
147 outer rotor
147a peripheral wall
147b bottom wall
148 cooling fan
149 magnet
170 power line
337 battery pack
381 LED (informing member)
S1 power switch (starting member)
H user's hand
H1 finger
H2 palm

What we claim is:

1. A power tool, comprising:
an engine for driving a tool bit,
a starting member that is operated to start the engine,
an operating member that is operated to adjust an output of the engine, and
a controller to idling stop the engine to by stopping a driving of the engine according to the operation of the operating member.

2. The power tool as defined in claim 1, wherein the operating member can be placed into an initial position in which the operating member is not operated yet, and an operated position in which the operating member has been operated, and wherein the controller stops driving of the engine when the operating member is returned from the operated position to the initial position.

3. The power tool as defined in claim 2, wherein the controller stops driving of the engine after a lapse of a first predetermined time since the operating member has been returned from the operated position to the initial position.

4. The power tool as defined in claim 2, wherein the controller restarts the engine without operating the starting member when the operating member is placed into the operated position again.

5. The power tool as defined in claim 2, further comprising a switching member which is selectively placed in either one of an operation enabled position in which operation of the operating member from the initial position to the operated position is enabled and an operation disabled position in which operation of the operating member from the initial position to the operated position is disabled, wherein, when the operating member is returned from the operated position to the initial position and the switching member is returned from the operation enabled position to the operation disabled position, the controller restarts the engine only by operation of the starting member.

6. The power tool as defined in claim 5, wherein, only when the operating member is placed into the operated position again within a second predetermined time with the switching member kept in the operation enabled position, the controller restarts the engine without operating the starting member.

7. The power tool as defined in claim 5, further comprising a housing that houses the engine, and a first handle to be held by a user, wherein the first handle protrudes from the housing, and the operating member and the switching member are provided on the first handle.

8. The power tool as defined in claim 7, wherein the operating member is provided in a region of the first handle which comes in contact with user's fingers, and the switching member is provided in a region of the first handle which comes in contact with user's palm.

9. The power tool as defined in claim 5, further comprising a housing that houses the engine, and a first handle and a second handle to be held by a user, wherein the first and second handles protrude from the housing, and the operating member is provided on the first handle and the switching member is provided on the second handle.

10. The power tool as defined in claim 4, further comprising an informing member for informing the user that the power tool is ready to restart the engine by user's operation of placing the operating member into the operated position again.
